(19) United States
(12) Patent Application Publication
(10) Pub. No.: US 2016/0124931 A1
(43) Pub. Date: May 5, 2016

(54) INPUT OF ELECTRONIC FORM DATA

(71) Applicant: International Business Machines Corporation, Armonk, NY (US)

(72) Inventors: Xiao X. Fan, Shanghai (CN); Yuan Jin, Shanghai (CN); Zhenni Lv, Shanghai (CN); Li ping Wang, Shanghai (CN); Wei Jun Zheng, Shanghai (CN)

(21) Appl. No.: 14/790,023

(22) Filed: Jul. 2, 2015

(30) Foreign Application Priority Data
Oct. 31, 2014 (CN) 201410602408.6

(51) Int. Cl. G06F 17/24; G06F 3/0481; G06F 3/0486

(52) U.S. Cl. CPC G06F 17/243; G06F 3/0486; G06F 3/04817

(57) ABSTRACT

A computer inputs electronic form data into an electronic form. The computer displays a form input interface. The form input interface includes a plurality of form fields that are arranged according to a predetermined order. The computer receives a specified inputting order that indicates an order of inputting data for at least one form field in need of data input. The computer receives a data that corresponds to the data input, needed by the at least one form field, in accordance with the specified inputting order.

### BACKGROUND

The present invention relates to input of electronic form data and, in particular, to human-computer interactions in inputting data on smart devices.

With the development of computer and communication networks, smart devices, such as mobile phones, are widely used. People can browse information and communicate messages with mobile smart devices in public places and use computers provided by service institutions (such as a bank) to make various transactions. In browsing web pages or making transactions, a user often needs to fill in electronic forms, namely, to input electronic form data.

An electronic form is typically comprised of a plurality of form fields. The manner of filling in the electronic form on a smart device is usually as follows. The smart device shows a list of form fields of the electronic form in order in a user interface provided on the screen, prompting the user to input data starting from the first one of the form fields in the list. The user may use an input device configured for the smart device, such as keyboard, to fill in a currently active form field, for example, by entering data into a blank data box corresponding to the form field. Upon completion of the filling of the current form field by the user, the smart device automatically activates a next form field for the user to fill in, until the user has completed the filling of all of required form fields. If the user does not want to fill out the form fields according to the default order or a predetermined order, they may also manually activate a particular form field, for example, by moving a screen pointer to the particular form field to activate it. In the case of many form fields and small display screen, several pages would be needed to display the entire electronic form. In manually activating form fields, the user needs to scroll the current page forward or backward to locate a form field to be activated, which is not conducive to efficiency when filling in the electronic form.

### SUMMARY OF THE INVENTION

Embodiments of the present invention provide a method, a computing system, and a program product to for inputting electronic form data. A processor displays a form input interface. The form input interface includes a plurality of form fields arranged according to a predetermined order. The processor receives a specified inputting order. The specified inputting order indicates an order of inputting data for at least one form field of the plurality of form fields. The at least one form field is in need of data input. The processor receives a data that corresponds to the data input needed by the at least one form field. The data that corresponds to the data input needed by the at least one form field is received in accordance with the specified inputting order.

### BRIEF DESCRIPTION OF THE DRAWINGS

Through the more detailed description of some embodiments of the present disclosure in the accompanying drawings will become more apparent, wherein the same reference generally refers to the same components in the embodiments of the present disclosure.

FIG. 1 shows a block diagram of an computer system/server, in accordance with an exemplary embodiment of the present invention;

FIG. 2 illustrates a flowchart of a method for inputting electronic form data into data fields included in an electronic form, in accordance with an exemplary embodiment of the present invention;

FIG. 3 illustrates a display/touch screen of a smart phone that shows an example of a form input interface, in accordance with an exemplary embodiment of the present invention;

FIG. 4A-4C illustratively show embodiments of user operations to specify the inputting order of the form fields shown in FIG. 3, in accordance with an exemplary embodiment of the present invention;

FIG. 5A-5E illustratively show user interfaces for filling in the form fields as shown in FIG. 3, in accordance with an exemplary embodiment of the present invention;

FIG. 6A-6E illustratively show user interfaces for filling in the form fields as shown in FIG. 3, in accordance with an exemplary embodiment of the present invention; and

FIG. 7 illustratively shows a block diagram of an apparatus, in accordance with an exemplary embodiment of the present invention.

### DETAILED DESCRIPTION

Some preferable embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

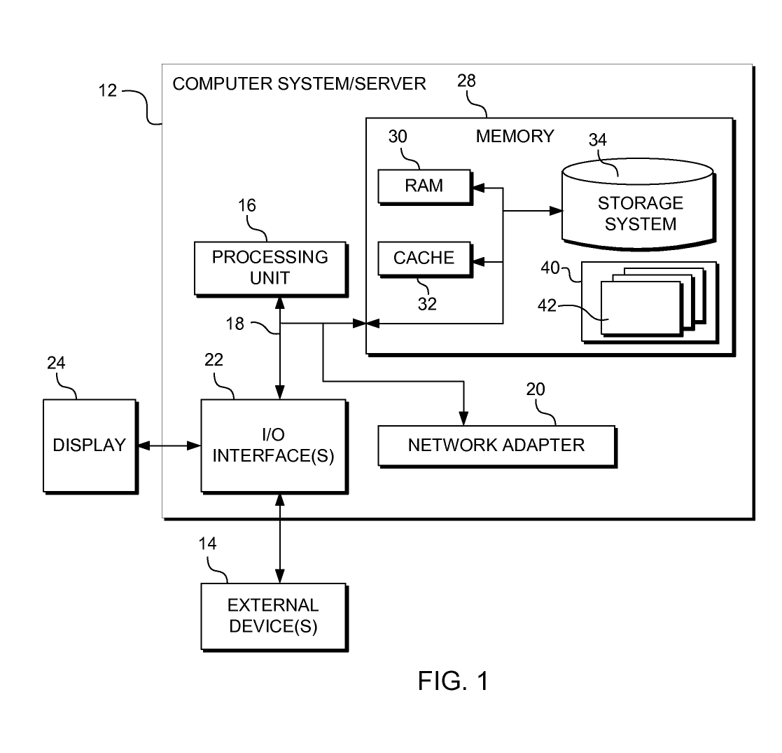

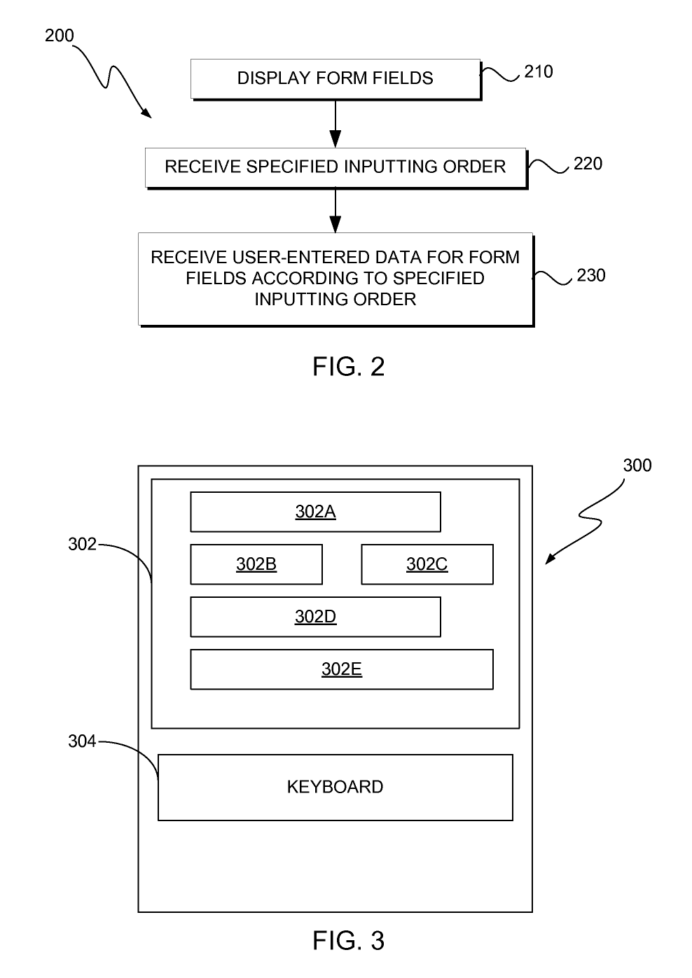

Referring now to FIG. 1, in which a computer system/server 12 is shown. Computer system/server 12 is only illustrative and is not intended to suggest any limitation as to the scope of use or functionality of embodiments of the invention described herein. In one embodiment, computer system/server 12 is configured to execute the method illustrated in FIG. 2. In one embodiment, computer system/server 12 includes a display/touch screen 300, as shown in FIG. 3.

As shown in FIG. 1, computer system/server 12 is shown in the form of a general-purpose computing device. As used herein, in some embodiments, computer system/server 12 is simply referred to as the “computing device.” The components of computer system/server 12 may include, but are not limited to, one or more processors or processing units 16, a system memory 28, and a bus 18 that couples various system components including system memory 28 to processor units 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, and external disk drive arrays, RAID systems, tape drives, and data archival storage systems, etc.

The computer system/server 12 shown in FIG. 1 and, in particular, those embodied as mobile smart devices equipped with touch screen are suitable for the implementation of embodiments of the invention.

Referring now to FIG. 2, which illustrates a flowchart, 200, of a method for inputting electronic form data into data fields included in an electronic form, in accordance with an exemplary embodiment of the present invention. The method as shown in the figure is suitable for implementation on one or both of a computer terminal and a computing device equipped with touch screen (for example, a smart phone or a tablet computer with a touchscreen). The method comprises three steps. In step 210 of displaying a form-input interface is displayed for a user. In step 220, a user specified inputting order is received. In step 230, of receiving user-entered data for the at least one form field in accordance with the specified inputting order. Detailed description of each of these three steps will be provided below with reference to other drawings.

It is well known that, in webpage or software applications, users are often required to fill in electronic forms, namely, to input electronic form data. Taking a scenario of visiting a shopping website using a smart phone as an example, the method 200 starts when a user of the smart phone needs to fill in an electronic form. First, Step 210 is executed.

In this example, in step 210, a form input interface is displayed for the user. The form input interface contains a plurality of form fields arranged according to a predetermined order.

With reference to this example and certain embodiments and scenarios, FIG. 3 illustrates a display/touch screen 300 of a smart phone that shows an example of a form input interface. As shown in FIG. 3, the touch screen of consists of two main areas. In one area, a touch screen keyboard, 304, is provided for user entry of data. In another area, a form input interface (hereinafter also referred to as “form input page” or simply “input page”) 302.

With reference to this example and certain embodiments and scenarios, input page 302, as shown, contains a plurality of form fields 302A, 302B, 302C, 302D and 302E of an electronic form. Those of skill in the art will readily appreciate that, an “electronic form”, which is also referred to “form” in the specification, contains a list of form fields. Each of the form fields includes an attribute name (such as name, address, etc.) and an input box. The input box is used for entering data therein, namely value of the attribute represented by the attribute name. The data may be of numeric type, logical type or textual type and the type of the form fields may be categorized into “mandatory” and “optional”. Since such details are well known to those of skill in the art, for the purpose of brevity, the form fields are represented by a labeled rectangular block in FIG. 3 and other figures, without showing those details irrelevant to the focus of the invention.

Form fields 302A, 302B, 302C, 302D and 302E have a predetermined order, i.e., 302A, 302B, 302C, 302D, and 302E.

It should be noted that, with continued reference to this example and certain embodiments and scenarios, input page 302 as shown in FIG. 3 only accommodates five form fields. In certain embodiments and scenarios, if more form fields are included in the electronic form, then input page 302 represents a current input page of the electronic form. In such embodiments and scenarios, by scrolling down input page 302, additional form fields of the electronic form may be displayed. Since the details of the functioning of such embodiments are readily appreciated by those of skill in the art, there is no need to provide those details herein. Moreover, the plurality of form fields as shown are from a single electronic form. However, in certain embodiments and scenarios, the plurality of form fields are from different electronic forms.

According to some techniques, a user may enter data for form fields 302A, 302B, 302C, 302D and 302E in the following way.

At the beginning, the first form field, 302A, is activated; for example, highlighted, prompting the user to input data for form field 302A. After entering data for form field 302A, the user clicks on the “Enter” key to indicate the completion of input. In response, the next form field, 302B, is automatically activated prompting the user to input data for form field 302B.

In the similar way, the user may enter data for the rest of the form fields, namely 302C, 302D and 302E, according to a predetermined order.

In the process of data-inputting, if the user wants to input data in an order that is different from the predetermined order, the user may manually select a form field for entering data next. For example, if, after data is entered for form field 302A, form field 302C should be chosen to input data, the user may click the position of form field 302C with a screen pointer (e.g., a mouse or a finger) to activate form field 302C. Then the user may enter data for form field 302C.

The user may fill in the electronic form in an order that is different from the predetermined order. However, during the input process, the user needs to use the screen pointer (e.g., a mouse or a finger) to designate a form field displayed on the current input page. If there are a large number of form fields, the user may also need to scroll the input page in order to select a form field that is not displayed on the current input page. That is not conducive to the ease of the input process.

Embodiments of the present invention reduce the number of actions required for the user to select a form field for entering data next in the process of data-inputting. Various embodiments of other steps of method 200 will be described below taking input page 302 as an example of the input page that is displayed in Step 210.

Referring back to FIG. 2. After Step 210, the process proceeds to Step 220.

In Step 220, a designated inputting order is received, the designated inputting order defines the order of inputting data for at least one form field, of the plurality of form fields, in need of data input.

In accordance with one embodiment, after input page 302 is displayed in step 210, the user is allowed to specify an inputting order, which in turn determines the order of inputting data for at least one form field, for which data input is required, in the plurality of form fields. For example, the user may specify to input data for five form fields, e.g., 302A, 302B, 302C, 302D, 302E, and in the order of “302B, 302A, 302C, 302E, 302D”. Alternatively, the user may specify to input data for four form fields, e.g., 302A, 302B, 302C, 302E, and in the order of “302B, 302A, 302C, 302E”. In general, the user-specified inputting order is received and recorded, at least temporarily, by the computing device.

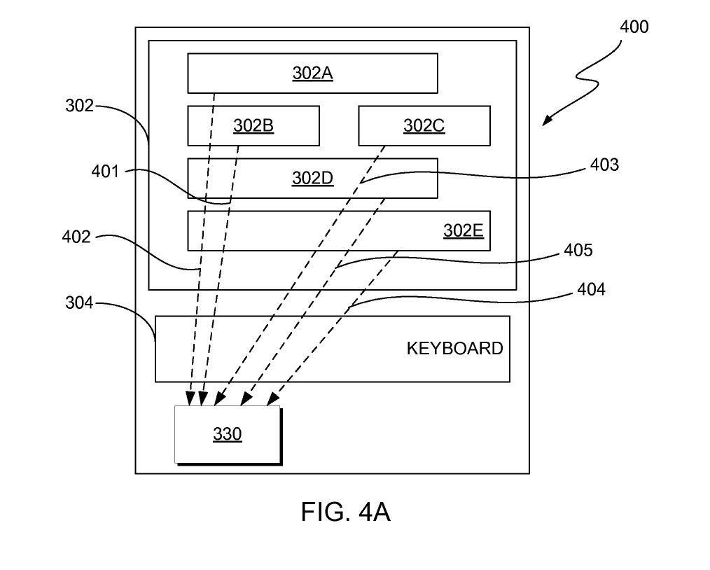

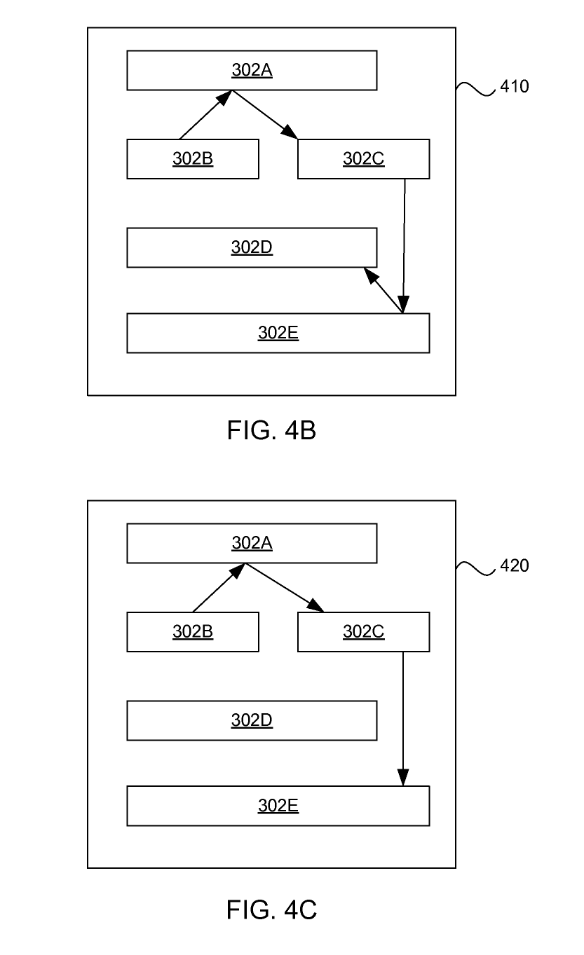

In accordance with one embodiment, the user may specify the inputting order before entering data for any form field in order to determine the order of inputting data for at least one form field of the plurality of form fields, for which the user deems data input is needed. In accordance with one embodiment, a process by which the user is enabled to specify the inputting order to the computing device (by which the computing device receives the user-specified inputting order), will be described below with reference to FIGS. 4A to 4C.

In accordance with one embodiment, in step 200, reception of the specified inputting order includes:

displaying an icon; and

in response to the user dragging and dropping individual form fields of the at least one form field to the icon one by one, recording the order in which the individual form fields are dragged and dropped to the icon as the specified inputting order.

Referring now to FIG. 4A, FIG. 4A illustratively shows the user operation of dragging and dropping individual form fields of the at least one form field to the icon one by one according with one embodiment.

As shown in FIG. 4A, display/touch screen 400, as included in one embodiment of the present invention, includes input page 302 includes a display of icon 330 to represent reordering. The user may use a screen pointer to drag and drop the form fields displayed in input page 302, in turn, to icon 330, the order in which the form fields are dragged and dropped representing the inputting order to be specified. As indicated by arrow 401, the user first selects form field 302B and drags it to icon 330. Then, the user drags form field 302A, form field 302C, form field 302E and form field 302D to icon 330 one by one, as indicated by arrows 402, 403, 404, and 405, which means that the user specified inputting order for the form fields is 302B, 302A, 302C, 302E, and 302D.

It should be noted that, in the context of the invention, the term “screen pointer” generally refers to any tool capable of pointing, moving, and drag-and-drop operations. For example, in the situation where a touch screen is used, the screen pointer might be a finger making touch actions. In the situation where a conventional screen is used, it might be the cursor of a mouse.

In some embodiments and scenarios, the method provides the user a process in which to drag a subset of the form fields displayed in input page 302 to icon 330. For example, the user may drag form fields 302B, 302A, 302C and 302E to icon 330 one by one to demonstrated that the user wishes to input data for form fields 302A, 302B, 302C, and 302E and the inputting order is therefore 302A, 302B, 302C, and 302E.

The above user operations may be detected by the computing device. As a response, the order in which each of the form fields are dragged to the icon is recorded by the computing device as the user specified inputting order.

In accordance with one embodiment, in step 220, receiving the specified inputting order includes: responsive to the user moving the screen pointer among individual form fields of the at least one form field, recording the order in which the screen pointer traverses individual form fields as the specified inputting order.

Referring now to FIG. 4B, FIG. 4B illustratively shows an example of a display/touch screen 410, included in a computing device in accordance with one embodiment. FIG. 4B illustrates the user interacting with input page 302 when the user to specifies the inputting order using input page 302, in accordance with one scenario and an embodiment of the present invention.

FIG. 4B demonstrates that the user, according to one embodiment of the method for inputting electronic form data into data fields included in an electronic form, is enabled to move the screen pointer along a curved path across the form fields displayed on form input interface 302 according to a desired order, with the path of movement representing the specified inputting order. For example, as shown by the arrows in FIG. 4B, the user touches form field 302B with their finger at first, and then moves their finger to form field 302A, to form field 302C, to form field 302E and then to form field 302D. The path of movement is therefore form field 302B, form field 302A, form field 302C, form field 302E, and then form field 302D, which indicates that data shall be input for form fields 302A, 302B, 302C, 302D, and 302E and the inputting order will therefore be form field 302B, form field 302A, form field 302C, form field 302E, and lastly form field 302D.

As a response, the order in which each of the form fields is traversed by the screen pointer is recorded by the smart phone as the specified inputting order.

Referring now to FIG. 4C, FIG. 4C illustratively shows an example of a display/touch screen 420, included in a computing device in accordance with one embodiment. FIG. 4C illustratively shows the operation of the user to specify the inputting order according to another embodiment of the invention.

The arrows in FIG. 4C bear the same meaning as the arrows in FIG. 4B. In FIG. 4C it is shown that the path of screen pointer's movement may traverse only a subset of the form fields displayed on form input interface 302. Here, for example, the path of movement is from form field 302B, to form field 302A, to form field 302C, and then to form field 302E, which indicates that data shall be input for form fields 302A, 302B, 302C, and 302E and that the inputting order for the form fields will be form field 302B, form field 302A, form field 302C, and lastly form field 302E.

In response to detection of the user traversing one or more of the form fields on form input interface 302, the computing device records the order in which each of the form fields is traversed by the screen pointer as the specified inputting order.

According to an embodiment of the invention, in input page 302 there may be displayed an option, such as a “reordering” button (not shown), to indicate that the user is allowed to specify an inputting order. In one such embodiment, the user may select the “reordering” button, and then select one or more of the at least one form fields included in on form input interface 302 one by one. Therefore, the order in which each form field is selected by the user represents the user specified inputting order, which may be recorded by the computing device.

In the above, embodiments of Step 220 are described, in which i) the specified inputting order is received and ii) different ways of operation of specifying the inputting order are illustrated by way of example.

It is to be noted that, in specific implementations and embodiments, additional options may be provided for the user to specify an inputting order as is understood by those skilled in the art. For example, in form input interface 302 there may be displayed a “confirm reordering” button (not shown). In one such embodiment, the user selects the “confirm reordering” button to indicate the completion of operation of specifying the inputting order. In another example, form input interface 302 includes an “undo” button (not shown). In one such embodiment, the user may select the “undo” button to initiate a revocation of the operation of specifying the inputting order. In yet another example, in one embodiment, form input interface 302 includes a “redo” button (not shown). In one such embodiment, the user may select the “redo” button to indicate that the operation of specifying the inputting order will be performed again to replace the last operation executed for specifying the inputting order. As all of the above options may be configured and would be understood by those skilled in the art according to specific scenarios, for the sake of brevity, additional details will not be described herein.

Referring again to FIG. 2, after Step 220, the process proceeds to Step 230.

In Step 230, user-entered data for the at least one form field is received by the computing device in the specified inputting order.

As mentioned above, in Step 220, the order, in which data shall be input for the at least one form field in need of data input from the plurality of form fields displayed in form input interface 302, is determined. For example, data shall be input for form fields 302A, 302B, 302C, 302D, and 302E, and the inputting order is from form field 302B, to form field 302A, to form field 302C, to form field 302E, and then to form field 302D. As mentioned above, solution for Step 230 includes the following steps. First, form field 302B in form input interface 302 is activated in accordance with the order of form field 302B, form field 302A, form field 302C, form field 302E, and then form field 302D, and the user-entered data for form field 302B is received. Then, form field 302A is activated and the user-entered data for form field 302A is received. Then, form field 302C is activated and the user-entered data for form field 302C is received. Then, form field 302E is activated and the user-entered data for form field 302E is received. In this way, finally, form field 302D is activated and the user-entered data for form field 302D is received.

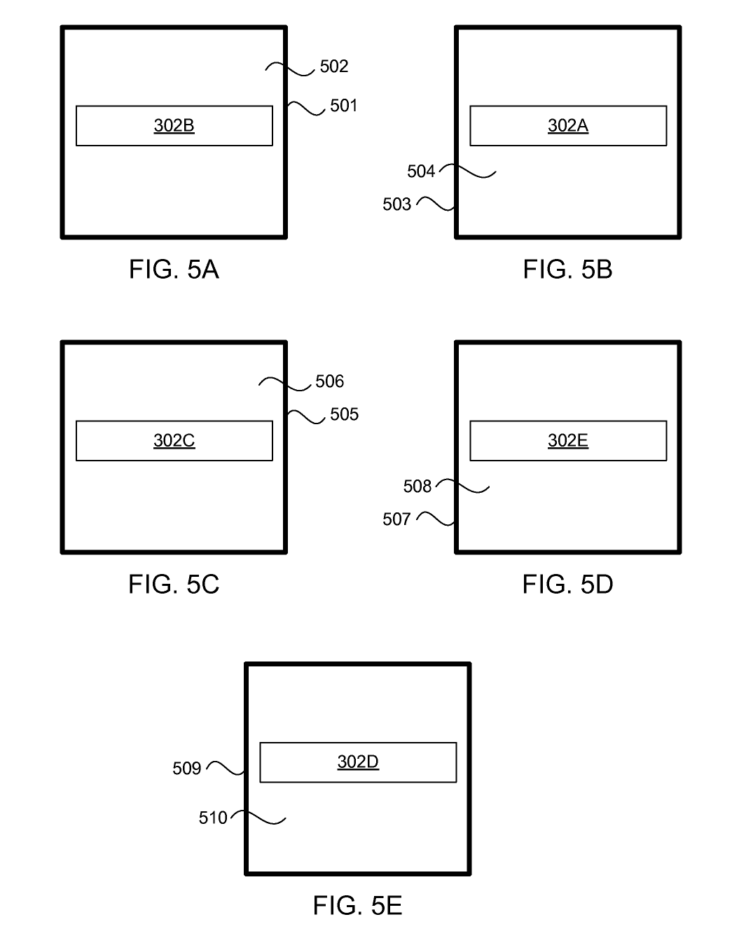

Referring to FIGS. 5A-5E, the implementation of Step 230 according a preferred embodiment of the invention will be described below, with the input of data for form fields 302A, 302B, 302C, 302D, 302E in the order of form field 302B, form field 302A, form field 302C, form field 302E, and form field 302D being taken for example.

According to an embodiment, in Step 230, receiving the user-entered data for the at least one form field in the specified inputting order includes displaying a form field in an additional window, wherein the form field is the one from the at least one form field for which data is to be entered immediately according to the specified inputting order.

Referring now to FIG. 5A, FIG. 5A illustratively shows a user interface for filling in the form fields as shown in FIG. 3 according to the user-specified inputting order in accordance with an embodiment of the invention.

FIG. 5A shows an additional window, 502, that is displayed on the screen of the computing device, in accordance with one embodiment. Displayed in the additional window (hereinafter also referred to as “window”) 502 is form field 302B. Form field 302B in window 502 corresponds to form field 302B of form input interface 302, which is the first form field in need of data input according to the user specified inputting order, which is the current form field displayed and activated for data input.

It should be noted that, in the context of the various embodiments, the term “additional window” refers to any position on the screen, as long as a form field displayed at that position is visually distinguishable from one or more other form fields of form input interface 302. Although a boundary, 501, is depicted in additional window 502, this is only illustrative rather than required. For example, if a form field displayed at the position is readily distinguishable from another form field in form input interface 302 in terms of, for example, color, font, or size, then in some embodiments, there is no need to display a boundary surrounding additional window 502. Note that in FIGS. 5B-5E, illustrating additional windows 504, 506, 508, and 510, each include their own respective boundary (i.e., one of boundary 503, 505, 507, and 509).

According to an embodiment of the invention, Step 230 of receiving the user-entered data for the at least one form field in the specified inputting order further comprises:

Receiving the user-entered data for the form field displayed in the additional window.

In the instant example, the user enters data for form field 302B, displayed in window 502, and the computing device receives that use-entered data.

According to an embodiment, in Step 230, receiving the user-entered data for the at least one form field in the specified inputting order includes:

In response to receiving user-entered data for a first form field displayed in an additional window, the computing device displays the next form field in the additional window, wherein the next form field is the form field that follows the first form field in accordance with the specified inputting order.

In the instant example, the computing device detects that the user has entered data for form field 302B, displayed in window 502, and the data entered was received by the computing device. Therefore, according to the user-specified inputting order of form field 302B, to form field 302A, to form field 302C, to form field 302E, and then to form field 302D, among form fields 302A, 302B, 302C, 302D, and 302E, form field A is next to, i.e., follows, form field 302B that corresponds to the data received by the computing device. Therefore, in response to receiving the entered data, the computing device automatically displays form field 302A in additional window 504.

The result is as shown in FIG. 5B. In FIG. 5A, form field 302B is displayed in window 502 provided on the screen of the computing device. In contrast, in FIG. 5B, form field 302A is displayed in additional window 504, which is displayed on the screen of the computing device.

As shown in FIG. 5C, after the user has finished entering data for form field 302A displayed in window 504, the next form field, in accordance with the user-specified inputting order, i.e., field form 302 C, is displayed in additional window 506.

As shown in FIGS. 5D and 5E, in a similar way, subsequently a next form field 302E is displayed in additional window 508 and the data entered for form field 302E is received by the computing device. Then, the next form field, i.e., form field 302D, is displayed in additional window 510 and the data entered for form field 302D is received by the computing device. In this embodiment and scenario, form field 302D is the last one to receive input data, and therefore, after the data has been entered for form field 302D and that data is received by the computing device, the process of filling in the current electronic form is ended.

In specific implementations, individual form fields (for example form field 302B and form field 302A) may be at different positions within a given additional window, in accordance with an embodiment.

According to one embodiment, the position of each individual form field is same. For example, the position of form field 302B in window 502 is same as the position of form field 302A in window 504. In some cases such an approach reduces the degree of distraction experienced by the user seeking to fill in data for various form fields that are at different positions.

According to one embodiment, an additional window is superimposed on form input interface 302.

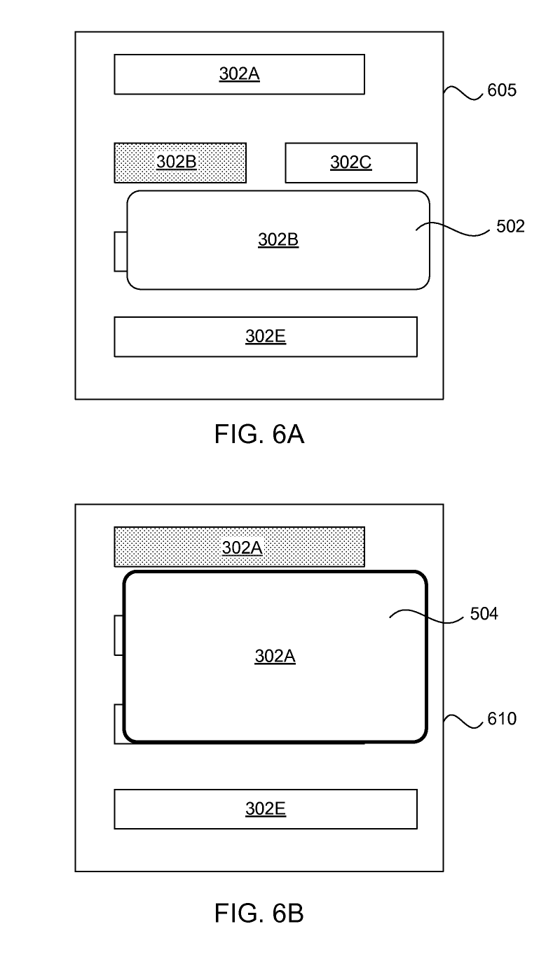

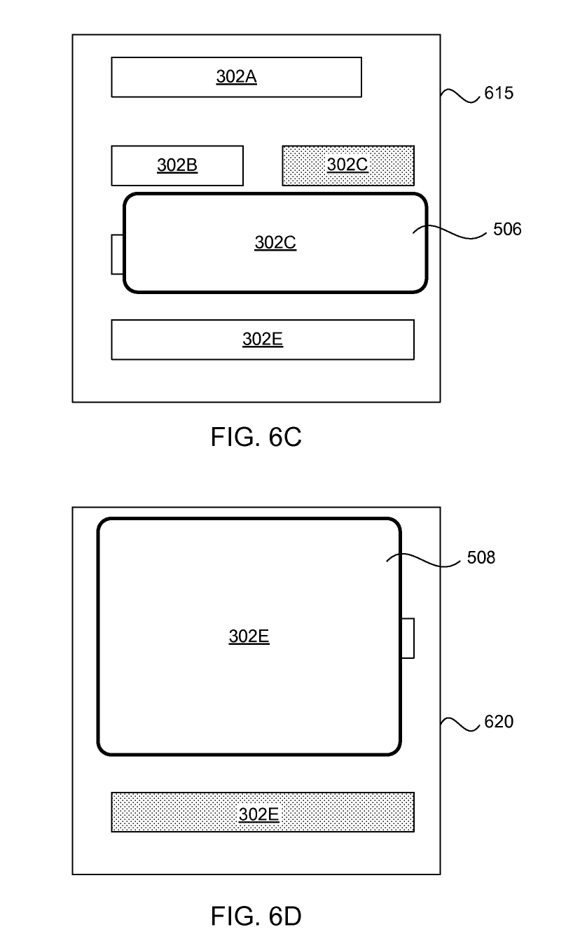

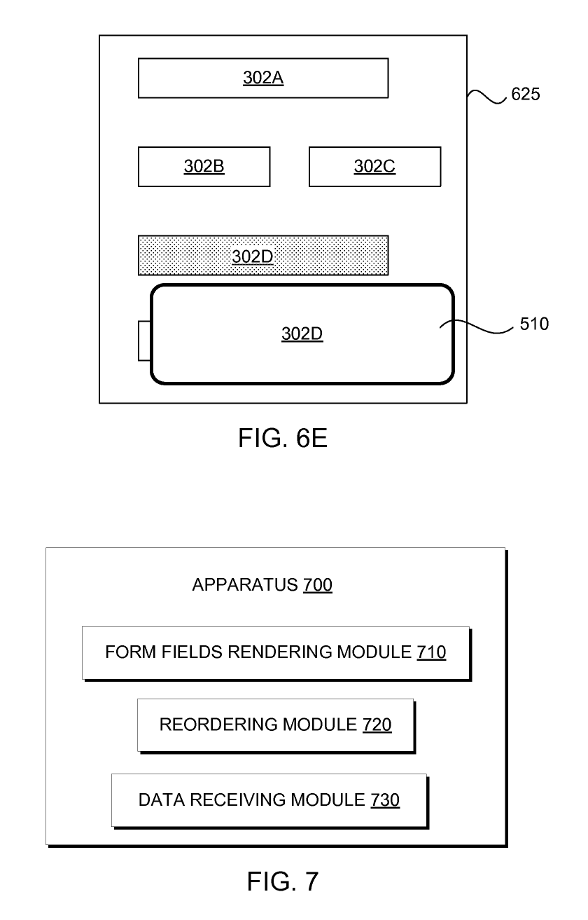

Referring now to FIGS. 6A-6E, FIGS. 6A-6E illustratively show user interfaces for filling in the form fields as shown in FIG. 3, according to user specified inputting order, and in accordance with an embodiment.

FIG. 6A shows a form input interface 605 that includes additional window 502, which contains form field 302B. As mentioned above with respect to FIG. 5A, additional window 502 may be displayed without showing its boundary. Here, window 602 is displayed as equivalent to additional window 502 but without boundary 501. Note that in FIGS. 6B-6E, additional windows 504, 506, 508, and 510 include their respective boundaries 503, 505, 507, and 509, as shown in FIGS. 5B-5E.

In FIG. 6A, additional window 502 is superimposed on form input interface 302, thereby generating form input interface 605. One difference between form input interface 605, shown in FIG. 6A, and form input interface 302, shown in FIG. 3 is that, in form input interface 605 shown in FIG. 6A, form field 302B is highlighted to represent that it corresponds to additional window 502 in form input interface 605.

Some differences between FIGS. 6B-6E and FIG. 6A respectively lie in the current form field that is selected within a given illustrated form input interface 610, 615, 620, and 625. In other words, the current form field that is selected within form input interface 605 of FIG. 6A is form field 302B, whereas the current form field within respective form input interfaces 610, 615, 620, and 625, of FIGS. 6B-6E, are respectively form field 302A, form field 302C, form field 302E, and form field 302D. Therefore, FIGS. 6A-6E are respectively in one-to-one correspondence with FIGS. 5A-5E.

In some embodiments, a given additional window may be either opaque or transparent. In one embodiment, if it is transparent, the user can observe the mapping relationship between the current form field in the additional window and the corresponded form field in the form input interface.

The various embodiments implementing the method of the invention have been described above with reference to the accompanying drawings. Those skilled in the art may understand that the method may be implemented in software, hardware or a combination of software and hardware. Moreover, those skilled in the art may understand by implementing various steps in the above method in software, hardware or a combination of software and hardware, there may be provided an apparatus for inputting electronic form data based on the same inventive concept. Even if the apparatus has the same hardware structure as a general-purpose processing device, the functionality of software contained therein makes the apparatus manifest distinguishing properties from the general-purpose processing device, thereby forming an apparatus of the various embodiments of the invention.

One embodiment of the present invention provides an apparatus for inputting electronic form data. FIG. 7 schematically shows a block diagram illustrating various modules of apparatus, 700, which is configured for inputting electronic form data in accordance with one such embodiment.

Apparatus 700 includes form fields rendering module 710, reordering module 720, and data receiving module 730.

In this embodiment, form fields rendering module 710 is configured to display a form input interface comprising multiple form fields arranged in a predetermined order.

In this embodiment, reordering module 720 is configured to receive a specified inputting order, the specified inputting order defining the order of inputting data for at least one of the plurality of form fields in need of data input.

In this embodiment, data receiving module 730 is configured to receive the data entered for the at least one form field in accordance with the specified inputting order.

According to one embodiment, data receiving module 730 comprises a single form field rendering module (not shown) that is configured to display a form field in an additional window. In one such embodiment, the displayed form field is selected based on both the specified inputting order and the last form field for which data was entered.

According to an embodiment, data receiving module 730 is further configured to receive the user-entered data for the form field displayed in the additional window.

According to an embodiment, form field rendering module 710 is further configured to, respond to reception of the user-entered data for the form field displayed in the additional window, by displaying the next form field, as indicated by the specified inputting order, in the additional window. In one such embodiment, the displayed form field is selected based on both the specified inputting order and the last form field for which data was entered.

According to an embodiment, the additional window is superimposed on the form input interface being displayed to the user.

According to an embodiment, reordering module 720 is configured to display an icon and, in response to the user dragging and dropping one or more individual form fields onto the icon one by one, determining the specified inputting order based on the order in which the individual form fields are dragged and dropped onto the icon.

According to an embodiment, reordering module 720 is configured to, respond to the user moving a screen pointer among individual form fields by determining the specified inputting order based on the order in which the screen pointer traverses individual form fields.

Embodiments of the apparatus for inputting electronic form data are described above. In the description of the embodiments of the apparatus for inputting electronic form data, details that are repetitive or derivable from the description of various embodiments of the method for inputting electronic form data are omitted.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or one embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that term(s) such as, for example, “Smalltalk” and the like may be subject to trademark rights in various jurisdictions throughout the world and are used here only in reference to the products or services properly denominated by the marks to the extent that such trademark rights may exist.

What is claimed is:

1. A method for inputting electronic form data, comprising:
displaying, by a processor, a form input interface, wherein the form input interface includes a plurality of form fields arranged according to a predetermined order;
receiving, by the processor, a specified inputting order, wherein the specified inputting order indicates an order of inputting data for at least one form field of the plurality of form fields, and wherein the at least one form field is in need of data input; and
receiving, by the processor, a data that corresponds to the data input needed by the at least one form field, wherein the data that corresponds to the data input needed by the at least one form field is received in accordance with the specified inputting order.

2. The method according to claim 1, wherein receiving, by the processor, user-entered data that corresponds to the data input needed by the at least one form field includes:
displaying, by the processor, the at least one form field in an additional display window based, at least in part on, the specified inputting order.

3. The method according to claim 2, wherein displaying, by the processor, the at least one form field in an additional display window based, at least in part on, the specified inputting order further includes:
receiving, by the processor, a data corresponding to the at least one form field that is displayed in the additional display window.

4. The method according to claim 3, wherein receiving, by the processor, a data corresponding to the at least one form field that is displayed in the additional display window further includes:
responsive to reception of the data corresponding to the at least one form field that is displayed in the additional display window, displaying, by the processor, a second form field in the additional display window, wherein the second form field is determined based on both the specified inputting order and the location of the at least one form field within the specified inputting order.

5. The method according to claim 2, wherein the additional display window is superimposed on the form input interface.

6. The method according to claim 1, wherein receiving, by the processor, a specified inputting order includes:
displaying, by the processor, an icon;
responsive to a determination that one or more individual form fields have been dragged and dropped onto the icon one by one, determining, by the processor, the specified inputting order based, at least in part, on the order in which the one or more individual form fields were dragged and dropped onto the icon.

7. The method according to claim 1, wherein receiving, by the processor, a specified inputting order includes:
responsive to a determination that a screen pointer has been moved from a third form field of the plurality of form fields to a fourth form field of the plurality of form fields, determining, by the processor, the specified inputting order based, at least in part, on the order in which the screen pointer traversed the third form field and the fourth form field.

8. A computer program product for inputting electronic form data, the computer program product comprising:
one or more computer-readable storage media and program instructions stored on the one or more computer-readable storage media, the program instructions comprising:
program instructions to display a form input interface, wherein the form input interface includes a plurality of form fields arranged according to a predetermined order;
program instructions to receive a specified inputting order, wherein the specified inputting order indicates an order of inputting data for at least one form field of the plurality of form fields, and wherein the at least one form field is in need of data input; and
program instructions to receive a data that corresponds to the data input needed by the at least one form field, wherein the data that corresponds to the data input needed by the at least one form field is received in accordance with the specified inputting order.

9. The computer program product according to claim 8, wherein the program instructions to receive a data that corresponds to the data input needed by the at least one form field include:
program instructions to display the at least one form field in an additional display window based, at least in part on, the specified inputting order.

10. The computer program product according to claim 9, wherein the program instructions to display the at least one form field in an additional display window based, at least in part on, the specified inputting order further include:
program instructions to receive a data corresponding to the at least one form field that is displayed in the additional display window.

11. The computer program product according to claim 10, wherein the program instructions to receive a data corresponding to the at least one form field that is displayed in the additional display window further include:
program instructions to respond to reception of the data corresponding to the at least one form field that is displayed in the additional display window by displaying a second form field in the additional display window, wherein the second form field is determined based on both the specified inputting order and the location of the at least one form field within the specified inputting order.

12. The computer program product according to claim 9, wherein the additional display window is superimposed on the form input interface.

13. The computer program product according to claim 8, wherein the program instructions to receive a specified inputting order include:
program instructions to display an icon;
program instructions to respond to a determination that one or more individual form fields have been dragged and dropped onto the icon one by one by determining the specified inputting order based, at least in part, on the order in which the one or more individual form fields were dragged and dropped onto the icon.

14. The computer program product according to claim 8, wherein the program instructions to receive a specified inputting order include:
program instructions to respond to a determination that a screen pointer has been moved from a third form field of the plurality of form fields to a fourth form field of the plurality of form fields by determining the specified inputting order based, at least in part, on the order in which the screen pointer traversed the third form field and the fourth form field.

15. A computer system for inputting electronic form data, the computer system comprising:
one or more computer processors;
one or more computer readable storage medium;
program instructions stored on the computer readable storage medium for execution by at least one of the one or more processors, the program instructions comprising:
program instructions to display a form input interface, wherein the form input interface includes a plurality of form fields arranged according to a predetermined order;
program instructions to receive a specified inputting order, wherein the specified inputting order indicates an order of inputting data for at least one form field of the plurality of form fields, and wherein the at least one form field is in need of data input; and
program instructions to receive a data that corresponds to the data input needed by the at least one form field, wherein the data that corresponds to the data input needed by the at least one form field is received in accordance with the specified inputting order.

16. The computer system according to claim 15, wherein the program instructions to receive a data that corresponds to the data input needed by the at least one form field include:
program instructions to display the at least one form field in an additional display window based, at least in part on, the specified inputting order.

17. The computer system according to claim 16, wherein the program instructions to display the at least one form field in an additional display window based, at least in part on, the specified inputting order further include:
program instructions to receive a data corresponding to the at least one form field that is displayed in the additional display window.

18. The computer system according to claim 17, wherein the program instructions to receive a data corresponding to the at least one form field that is displayed in the additional display window further include:
program instructions to respond to reception of the data corresponding to the at least one form field that is displayed in the additional display window by displaying a second form field in the additional display window, wherein the second form field is determined based on both the specified inputting order and the location of the at least one form field within the specified inputting order.

19. The computer system according to claim 15, wherein the program instructions to receive a specified inputting order include:
program instructions to display an icon;
program instructions to respond to a determination that one or more individual form fields have been dragged and dropped onto the icon one by one by determining the specified inputting order based, at least in part, on the order in which the one or more individual form fields were dragged and dropped onto the icon.

20. The computer system according to claim 15, wherein the program instructions to receive a specified inputting order include:
program instructions to respond to a determination that a screen pointer has been moved from a third form field of the plurality of form fields to a fourth form field of the plurality of form fields by determining the specified inputting order based, at least in part, on the order in which the screen pointer traversed the third form field and the fourth form field.
